(19) United States
(12) Patent Application Publication
(10) Pub. No.: US 2004/0267403 A1
(43) Pub. Date: Dec. 30, 2004

(54) Specimen sorting system

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/845,146

(22) Filed: May 14, 2004

(30) Foreign Application Priority Data
May 30, 2003 (JP) 2003-155252

(51) Int. Cl. G06F 7/00

(52) U.S. Cl. 700/214; 235/375; 209/552

(57) ABSTRACT

In a specimen sorting system, the presence of a specimen case holder can easily be detected, and specimen-related information relating to a specimen in a specimen case that is held by the specimen case holder can be obtained at the same time. In this specimen sorting system, an information transmission/reception tag is attached to the specimen case holder, and an information transmitter/receiver is disposed near the side of a conveyor lane that conveys the specimen case holder. The specimen case held by the specimen case holder is sorted on the basis of information transmission/reception between the information transmission/reception tag and information transmitter/receiver.

### CROSS-REFERENCE TO RELATED APPLICATIONS

This application is based upon and claims the benefit of priority from prior Japanese Patent Application No. 2003-155252, filed May 30, 2003, the entire contents of which are incorporated herein by reference.

### BACKGROUND OF THE INVENTION

1. Field of the Invention

The present invention relates to a specimen sorting system for sorting a specimen, such as blood, in accordance with, e.g. test items.

2. Description of the Related Art

A specimen, such as blood, is conveyed in the state in which it is contained in a specimen case such as a test tube. The specimen is sorted by reading of information relating to the specimen (hereinafter referred to as “specimen-related information”) that is indicated on a barcode label or the like attached on an outer peripheral surface of the specimen holder. In this case, however, there are the following difficulties. The barcode label or the like has only a small amount of information, and read/write of information is relatively time-consuming and requires a large-scale apparatus.

On the other hand, there is known a specimen sorting system that conveys and sorts a specimen case holder in the state in which a specimen case is held in the specimen case holder for conveyance, which is termed “columnar rack.” In this type of specimen sorting system, a metallic indication ring is provided on the outer circumference of the specimen case holder. Thereby, the conveying of the specimen case holder is easily detected (see the Abstract of Jpn. Pat. Appln. KOKAI Publication No. 8-220105). According to this technique, a metal sensor detects the indication ring, thus determining the position of the specimen case holder.

This indication ring, however, is an annular metal member and has nothing to do with specimen-related information. As mentioned above, it is necessary to read specimen-related information from a barcode label or the like attached to the specimen case.

### BRIEF SUMMARY OF THE INVENTION

The object of the present invention is to provide a specimen sorting system that can easily detect the presence of a specimen case holder and can at the same time acquire specimen-related information relating to a specimen contained in a specimen case that is held in the specimen case holder.

According to an aspect of the present invention, there is provided a specimen sorting system wherein an information transmission/reception tag is attached to a specimen case holder that holds a specimen case, an information transmitter/receiver is disposed near a side of a conveyor lane that conveys the specimen case holder, and the specimen case that is held by the specimen case holder is sorted on the basis of information transmission/reception between the information transmission/reception tag and the information transmitter/receiver.

Other aspects of the present invention will be described in connection with the embodiment of the invention.

### BRIEF DESCRIPTION OF THE SEVERAL VIEWS OF THE DRAWING

FIG. 1 shows the structure of a specimen sorting system according to an embodiment of the present invention; and

FIG. 2 is a perspective view showing an external structure of a specimen case holder according to the embodiment.

### DETAILED DESCRIPTION OF THE INVENTION

An embodiment of the present invention will now be described with reference to the accompanying drawings.

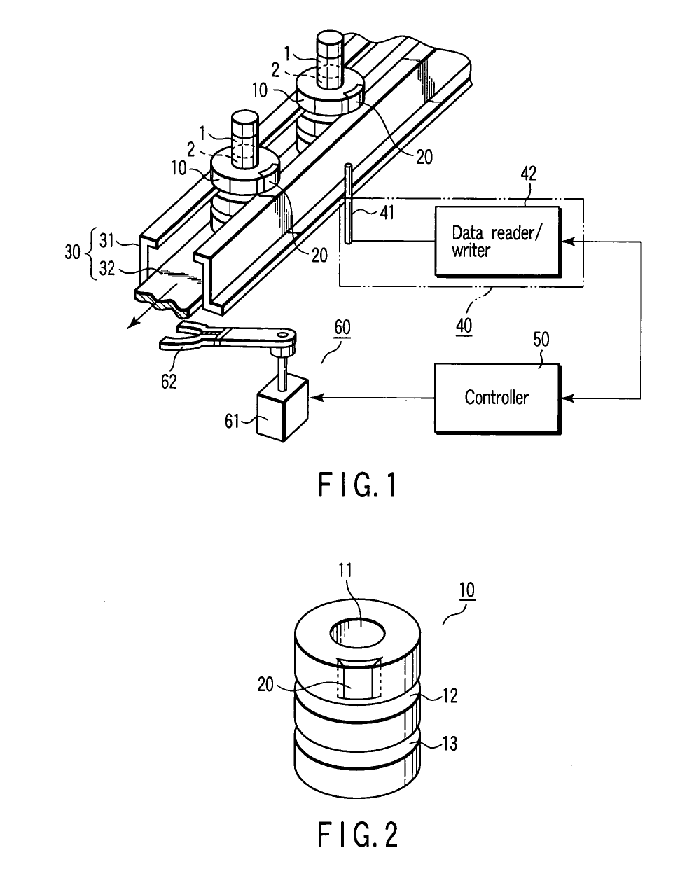

FIG. 1 shows the structure of a specimen sorting system according to the embodiment of the present invention. FIG. 2 is a perspective view showing an external structure of a specimen case holder in the embodiment.

In FIG. 1, a specimen 2, such as blood, is contained in a specimen case 1 that is formed of a test tube. The specimen case 1 is conveyed to a target position by means of a conveyor lane 30 in the state in which the specimen case 1 is vertically held in a specimen case holder 10 for conveyance. The conveyor lane 30 comprises a guide rail 31 with a pair of mutually opposed parallel edge portions, and a belt conveyor 32 that is driven in the direction of an arrow (in FIG. 1) along the longitudinal axis of a bottom part of the guide rail 31.

The specimen case holder 10 is generally termed “columnar rack”. As is shown in FIG. 2, the specimen case holder 10 has a substantially cylindrical shape as a whole. A hollow portion 11 is provided in a central axial part of a cylindrical base of the specimen case holder 10. Two annular grooves 12 and 13 are formed in an outer peripheral part of the cylindrical base with a predetermined interval. The annular groove 12 is a groove for preventing falling of the holder during conveyance. During conveyance, the annular groove 12 is slidably engaged with the edge portions of the guide rail 31 of conveyor lane 30. The other annular groove 13 is a groove for controlling stopping of the specimen case holder 10. When the specimen case holder 10 is conveyed to a stop position, a stopper pin (not shown) is horizontally projected at the stop position and inserted in a front part (as viewed in the direction of movement) of the groove 13.

An information transmission/reception tag 20 is attached to an uppermost part of the outer periphery of the specimen case holder 10. The information transmission/reception tag 20 is configured such that an antenna and an IC chip are buried in a card-shaped base plate. The IC chip stores specimen-related information relating to the specimen 2 in the specimen case 1 that is held. The specimen-related information includes, for instance, a specimen identifier and test item(s). The specimen-related information can be read out to the outside, where necessary.

Referring back to FIG. 1, an information transmitter/receiver 40 is disposed at a predetermined position along the side of the conveyor lane 30. The information transmitter/receiver 40 comprises a transmission/reception antenna 41 and a data reader/writer 42. The data reader/writer 42 is connected to a controller 50.

The operation of the information transmitter/receiver 40 is controlled on the basis of a control signal from the controller 50. The information transmitter/receiver 40 reads the specimen-related information from the information transmission/reception tag 20 via the transmission/reception antenna 41 using radio waves with a predetermined frequency. The read specimen-related information is delivered to the controller 50. The data reader/writer 42 can, where necessary, rewrite the specimen-related information stored in the information transmission/reception tag 20.

The controller 50 issues a predetermined instruction to a robot 60 on the basis of the specimen-related information that is read out of the information transmission/reception tag 20 by the data reader/writer 42. The robot 60 comprises a main body 61 and an arm section 62. In accordance with the instruction from the controller 50, the robot 60 sorts the specimen case holder 10 that is conveyed by the conveyor lane 30. Thereby, the sorting of the specimen case 1 held in the specimen case holder 10, that is, the sorting of the specimen 2, can be performed.

(Features of the Embodiment)

[1] The specimen sorting system according to the embodiment is characterized in that an information transmission/reception tag 20 is attached to a specimen case holder 10 that holds a specimen case 1, an information transmitter/receiver 40 is disposed near a side of a conveyor lane 30 that conveys the specimen case holder 10, and the specimen case 1 that is held by the specimen case holder 10 is sorted on the basis of information transmission/reception between the information transmission/reception tag 20 and the information transmitter/receiver 40.

In this specimen sorting system, the information transmission/reception tag 20 is attached to the specimen case holder 10, and information transmission/reception is effected between the information transmission/reception tag 20 and the information transmitter/receiver 40 disposed near the side of the conveyor lane 30, thereby obtaining specimen-related information relating to the specimen 2 in the specimen case 1 held by the specimen case holder 10. Therefore, in addition to the feature that the presence of the specimen case holder 10 can be detected, the specimen-related information relating to the specimen 2 in the specimen case 1 can exactly be obtained at the same time and quickly.

[2] The specimen sorting system according to the embodiment is characterized in that the method of the information transmission/reception described in the above feature [1] is a radio wave method.

(Modifications)

The specimen sorting system described in the feature [1] of the embodiment includes the following modifications (i) and (ii):

(i) A structural feature that the information transmission/reception between the information transmission/reception tag 20 and information transmitter/receiver 40 is effected by a magnetic method, an induction method or an electrostatic method.

(ii) A structural feature that the information transmission/reception tag 20 is formed in an annular shape so as to be fittable on the outer periphery of the specimen case holder 10. The modification (ii) is included in the feature [2] of the embodiment.

In any case, according to the present embodiment, the specimen-related information relating to the specimen 2 in the specimen case 1 that is held by the specimen case holder 10 is obtained by the structure wherein information is transmitted/received between the information transmission/reception tag 20 of specimen case holder 10 and the information transmitter/receiver 40 disposed near the side of the conveyor lane 30. Therefore, the presence of the specimen case holder 10 and the associated specimen-related information can exactly be obtained at the same time and quickly.

The present invention is not limited to the above-described embodiment and modifications. Various modifications can be made in practice without departing from the spirit of the invention. The embodiment and modifications can be combined as much as possible, and the combined advantages can be obtained in such cases. Furthermore, the embodiment and modifications include inventions in various stages, and various inventions can be derived from desired combinations of structural elements disclosed herein. For example, if an invention is extracted by omitting some of all the structural elements disclosed in the embodiment, well-known art is properly substituted for the omitted elements in practicing the extracted invention.

In addition, the present invention can be variously modified in practice without departing from the spirit of the invention.

What is claimed is:

1. A specimen sorting system wherein an infor-mation transmission/reception tag is attached to a specimen case holder that holds a specimen case, an information transmitter/receiver is disposed near a side of a conveyor lane that conveys the specimen case holder, and the specimen case that is held by the specimen case holder is sorted on the basis of information transmission/reception between the information transmission/reception tag and the information transmitter/receiver.

2. The specimen sorting system according to claim 1, wherein the information transmission/reception between the information transmission/reception tag and the information transmitter/receiver is effected by a radio wave method.

3. A specimen sorting system that conveys and sorts a specimen case holder that holds a specimen case containing a specimen, comprising:
an information transmission/reception tag that is attached to the specimen case holder and is capable of transmitting/receiving specimen-related information relating to the specimen;
conveyor means for conveying the specimen case holder;
an information transmitter/receiver that is disposed near a side of the conveyor means and is capable of transmitting/receiving the specimen-related information to/from the information transmission/reception tag; and
sorting means for sorting the specimen case holder on the basis of the specimen-related information obtained from the information transmitter/receiver.
